(19) United States
(12) Patent Application Publication
(10) Pub. No.: US 2024/0127237 A1
(43) Pub. Date: Apr. 18, 2024

(54) MANAGING CUSTOMER INFORMATION AND TRANSACTION RECORDS ON A DISTRIBUTED LEDGER

(71) Applicant: DISH Wireless L.L.C, Littleton, CO (US)

(72) Inventors: Ahmed Alkarboly, Denver, CO (US); Derek Dalmer, Aurora, CO (US); Jennings Orcutt, Denver, CO (US); Joel Maron, Denver, CO (US); Pallavi Kondapalli, Littleton, CO (US); Andrew Toig, Denver, CO (US); Zuri Wright, Denver, CO (US)

(21) Appl. No.: 18/479,532

(22) Filed: Oct. 2, 2023

Related U.S. Application Data
(60) Provisional application No. 63/416,181, filed on Oct. 14, 2022.

(51) Int. Cl. G06Q 20/38; G06Q 20/40; H04L 9/00

(52) U.S. Cl. CPC G06Q 20/389; G06Q 20/3823; G06Q 20/401; H04L 9/50

(57) ABSTRACT

Systems and methods for using a distributed ledger to maintain a blockchain are provided. An example method includes receiving transaction information associated with a transaction involving a service provider and a consumer, the transaction information including transaction terms and conditions, receiving an indication, the indication indicating that the consumer assented to the terms and conditions, creating a transaction record, the transaction record including a transaction identifier, a consumer identifier of the consumer, the transaction terms and conditions, and the indication, creating a block in a blockchain managed by a blockchain as a service (BaaS) system, and storing the transaction record in the block.

### CROSS REFERENCE TO RELATED APPLICATIONS

This application claims priority to U.S. Provisional Patent Application No. 63/416,181, filed on Oct. 14, 2022, the disclosure of which is incorporated by reference in its entirety for all purposes.

### BACKGROUND

Managing customer information is a complex process, particularly recording and storing the details of the transaction between a customer and an entity accurately. The enormous scale of customer records running into the millions only compounds the problems associated with record management.

Blockchain is a form of digital ledger technology (DLT) that allows a growing list of records or “blocks” to be maintained that are securely linked together using cryptography. Timestamps are incorporated as part of the blocks to prove when records on the blockchain were created. Since each block is built upon information derived from the previous block, a “chain” of blocks is formed. Since each block in the chain is created based in part on data from the previous block, data cannot be altered in a previous block without also altering subsequent blocks.

Blockchains can be maintained in the form of a distributed ledger across peer-to-peer computer networks, which can be public or private. Using a distributed ledger for the creation and storage of the blockchain helps maintain the veracity and security of each block by simultaneously storing the entire digital ledger in multiple locations using different hardware and infrastructure. Use of a decentralized network enables trustless and permissionless transactions on a blockchain that can be viewed and verified by any party with view access to the blockchain ledger.

Utilizing blockchain to record a transaction is beneficial because it ensures an immutable record that can be used later for reference, and also provides an efficient way to access the record at any time after the transaction has been recorded. A blockchain enables trustless transactions on a distributed network that can be viewed and verified by any party with view access to the blockchain ledger. A public blockchain, such as Ethereum, is one where any person with the required technology, generally a computer and Internet access, can see the transactions on the distributed ledger, interact with the blockchain by creating new transactions, and/or participate in securing the network by validating transactions. A private blockchain is one in which users must have “permission” from the network to either view the transactions on the distributed ledger or interact with the blockchain, and the transactions are secured and validated by one or more private parties.

### SUMMARY

In accordance with some embodiments of the present disclosure, a computer-implemented method is provided. In one example, the method includes: receiving transaction information associated with a transaction involving a service provider and a consumer, the transaction information including transaction terms and conditions, receiving an indication, the indication indicating that the consumer assented to the terms and conditions, creating a transaction record, the transaction record comprising a transaction identifier, a consumer identifier of the consumer, the transaction terms and conditions, and the indication, creating a block in a blockchain managed by a blockchain as a service (BaaS) system, and storing the transaction record in the block.

In another example, a method includes: receiving first transaction information associated with a transaction involving a service provider and a consumer, the first transaction information including first transaction terms and conditions, receiving a first indication, the first indication indicating that the consumer assented to the first terms and conditions at a first time point, creating a first transaction record, the first transaction record including a transaction identifier, a consumer identifier of the consumer, the first transaction terms and conditions, and the first indication, creating a first block in a blockchain managed by a BaaS system, storing the first transaction record in the first block, receiving second transaction information associated with the transaction between the service provider and the consumer, the second transaction information including second transaction terms and conditions different from the first transaction terms and conditions, receiving a second indication, the second indication indicating that the consumer assented to the second terms and conditions at a second time point subsequent to the first time point, creating a second transaction record, the second transaction record including the transaction identifier, the consumer identifier of the consumer, the second transaction terms and conditions, and the second indication, creating a second block in the blockchain, and storing the second transaction record in the second block.

In another example, a method includes: receiving transaction information regarding a transaction involving a service provider and a consumer, identifying sensitive consumer information and non-sensitive consumer information included in the transaction information, generating one or more public records containing the non-sensitive consumer information, generating one or more private records containing the sensitive consumer information, storing the public records in a public block of a public blockchain, storing the private records in a private block of a private blockchain, and generating a reference directed to the corresponding private records and storing the reference in the public block. The method may further include receiving a request for access to sensitive consumer information using the reference from a requesting party, authenticating the requesting party, and in response to a determination that the requesting party is authenticated, granting access to the private records to the requesting party.

In accordance with some embodiments of the present disclosure, a system is provided. In one example, the system includes: one or more processors and a computer-readable storage media storing computer-executable instructions. The computer-executable instructions, when executed by the one or more processors, cause the system to: receive transaction information associated with a transaction involving a service provider and a consumer, the transaction information including transaction terms and conditions, receive an indication, the indication indicating that the consumer assented to the terms and conditions, create a transaction record, the transaction record comprising a transaction identifier, a consumer identifier of the consumer, the transaction terms and conditions, and the indication, create a block in a blockchain managed by a blockchain as a service (BaaS) system, and store the transaction record in the block.

In accordance with some embodiments, the present disclosure also provides a non-transitory machine-readable storage medium encoded with instructions, the instructions executable to cause one or more electronic processors of a system to perform any one of the methods described in the present disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a blockchain architecture configuration, according to various embodiments.

FIG. 1B illustrates an example of a blockchain transactional flow between nodes of a blockchain in accordance with various embodiments.

FIG. 2A illustrates a block diagram of an example blockchain used to store transaction information regarding a transaction according to various embodiments.

FIG. 2B illustrates an exemplary transaction record represented by the transactions of FIG. 2A, according to various embodiments.

FIG. 2C illustrates a block diagram of an example of a hybrid blockchain system for accessing public and private records related to a transaction according to various embodiments.

FIG. 3A illustrates a block diagram of an example system for using a private distributed ledger to maintain a blockchain of transaction.

FIG. 3B illustrates a block diagram of an example system for using a hybrid system of distributed ledgers to maintain a blockchain of transaction.

FIG. 4 is a flow diagram illustrating an example method for using a distributed ledger to maintain a blockchain of transaction according to various embodiments.

FIG. 5 is a flow diagram illustrating another example method for using a distributed ledger to maintain a blockchain of transaction according to various embodiments.

FIG. 6 is a flow diagram illustrating another example method for using a distributed ledger to maintain a blockchain of transaction according to various embodiments.

FIG. 7 is a block diagram illustrating an example computer system or computer device, according to various embodiments.

### DETAILED DESCRIPTION

Historically, transactions between two parties, whether corporations or an individual, have been recorded on paper with a wet signature and stored in the paper format. Electronic storage of documents ushered in an efficient and cost-effective way of storing and managing the documents, while the clickwrap (described below) approach introduced a new way of recording assent from each party. As used herein, “transactions” means any binding agreement between two or more parties.

The problem of recording, storing and managing transactions is further complicated when a large number of parties is involved, as with any consumer-facing business. As an example, a consumer-facing company may be required to record, store and manage hundreds of thousands or millions of transactions in order to provide products or services to their consumers. Currently, the common industry practice is to provide the consumer with a pre-determined set of terms and conditions that govern both parties' obligations towards each other with respect to the product or service that the company offers in the market. Typically, the party that is presented with the terms and conditions, in most cases the consumer, accepts the terms and conditions by clicking a checkbox, or another medium presented to the consumer via a graphical user interface. This form of recording a party's assent is also called the clickwrap or slinkwrap agreement. The agreement thus formed can be stored electronically, in a digital format, and a physical copy may be retained by both parties.

However, this form of recording, storing and managing the transactions in an electronic format has a host of emerging problems. First, the number of consumers, particularly consumers using electronic devices and services, has burgeoned in the past couple of decades. Second, the amount of data that is being processed, either because of the increased volume of consumers or because of the advanced nature of the products and services being offered in the market, calls for better ways of handling the information. Consider cellular network service providers, television service distribution companies, and video streaming service providers—each of which have large numbers of consumers and provide a variety of products and services with a different set of terms and conditions for each product or service. Additionally, each of such organizations may have new consumers signing their terms and conditions on an ongoing basis, creating copious amounts of data.

While each consumer may be required to agree to specific terms and conditions of the transactions, these terms may be updated over time that apply to the product or service in question. It may be beneficial to record the specific version of terms and conditions to which the consumer explicitly agreed and in addition, as and when the terms of the terms are updated, an updated version of the transaction is also generated to record the new terms that the consumer has assented to. Proving that the consumer assented to a particular version of the transactions may be needed a significant time later, either for legal proceedings or other purposes. For instance, a consumer may have agreed to a transaction with a service provider. The service provider can update certain terms of the transactions from time to time, and may provide notice of the updated transactions to the consumer. Each of the aforementioned update can be recorded on the BC as a transaction. Years later the service provider will have access to the exact version of the transaction that the consumer originally assented to, along with each of the later updated versions of the transactions, to provide evidence that the consumer assented to a specific terms of the transactions that may be in dispute.

While such information may be stored in a database, a blockchain (BC) stored on a distributed ledger can have many advantages. Specifically, qualities of BC such as immutability, transparency, security, and traceability of data ensure that the transactions are recorded, stored and managed in an efficient manner. Additionally, it may be relatively easy to prove the veracity of entries in a distributed-ledger BC years later. Specific information around the circumstances of the consumer's assent to the transactions can also be recorded to the BC to help prove that the consumer did in fact review and assent to the transactions. As an example, specific explanatory audio recordings or video recordings can be recorded in the form of non-fungible tokens (NFTs) on the BC along with information about whether or not the consumer heard/viewed the recordings and for what duration. Further, data stored on the BC can be linked to data stored elsewhere that the organization does not desire to have directly recorded on the BC. For instance, if a public BC is used, specific consumer data (e.g., a consumer's name) may instead be referenced by a BC record and stored on a private server. In some embodiments, the data stored on the BC can be utilized to prevent fraudulent activities. For instance, a cellular service provider may utilize the data to prevent various kinds of fraud such as traffic pumping, SIM or device swaps, abuse of service plans, etc.

Throughout this document, the term “service provider” is used. In some embodiments, the term “product provider” can be used in various embodiments in lieu of service provider to refer to situations where a product is provided rather than a service.

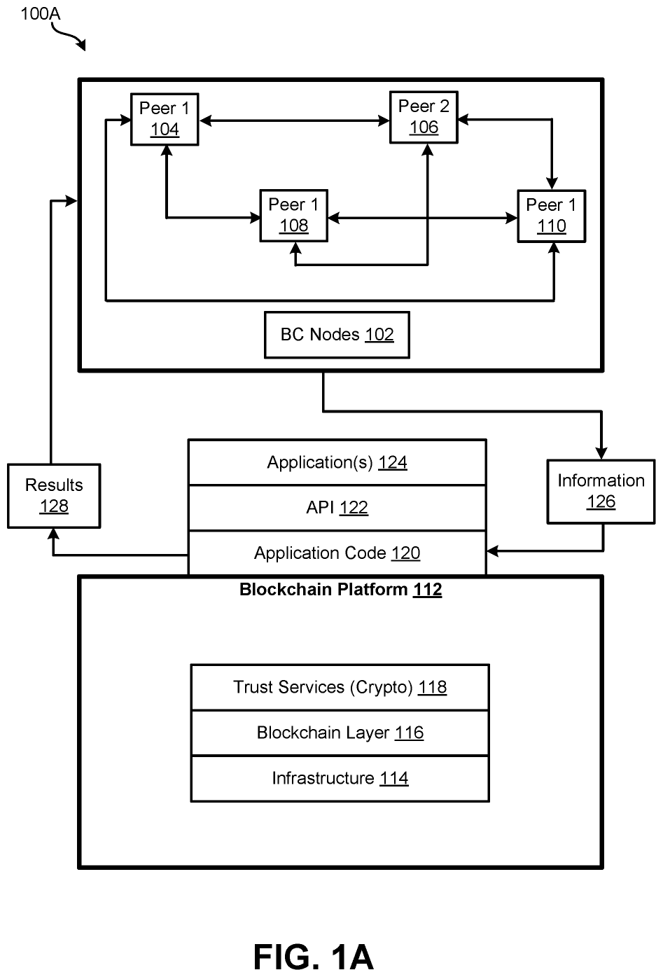

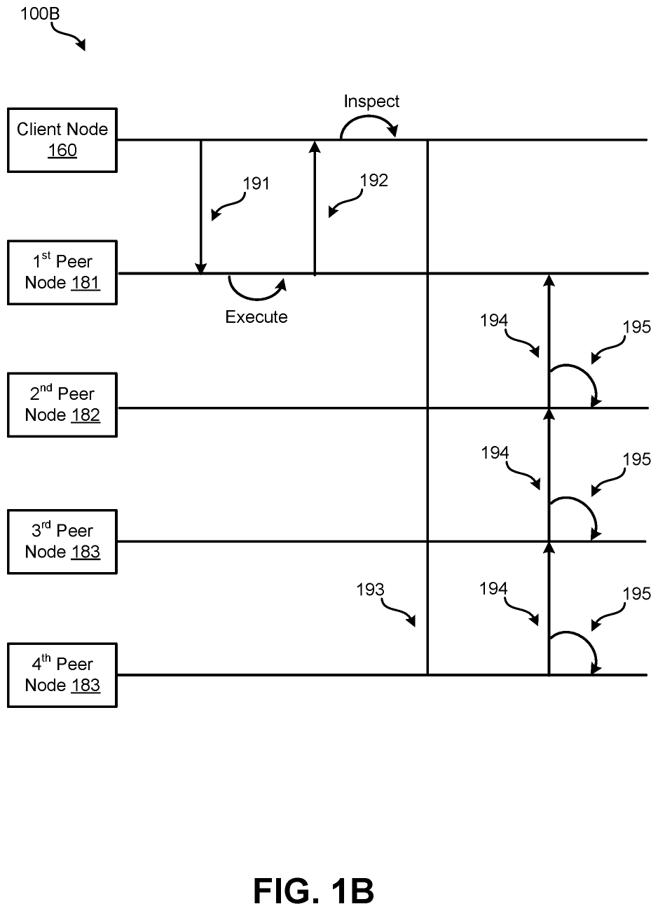

Further detail regarding such embodiments is provided in relation to the figures. FIG. 1A illustrates a blockchain architecture configuration 100, according to various embodiments. In the illustrated example, the blockchain architecture 100 may include certain blockchain elements, for example, a group of blockchain nodes 102. The blockchain nodes 102 may include one or more nodes 104-110 (these four nodes are depicted by example only). These nodes participate in a number of activities, such as blockchain transactions, transaction addition processes, and transaction validation processes, and so on. One or more of the blockchain nodes 104-110 may endorse transactions based on endorsement policy and may provide an ordering service for all blockchain nodes in the architecture 100. A blockchain node may initiate a blockchain authentication and seek to write to a blockchain immutable ledger stored in blockchain layer 116, a copy of which may also be stored on the underpinning physical infrastructure 114. The blockchain configuration may include one or more applications 124 which are linked to application programming interfaces (APIs) 122 to access and execute stored program/application code 120 (e.g., transaction records, chain codes, smart contracts, etc.) which can be created according to a customized configuration sought by participants and can maintain their own state, control their own assets, and receive external information. This can be deployed as a transaction and installed, via appending to the distributed ledger, on all blockchain nodes 104-110.

The blockchain base or platform 112 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 116 may expose an interface that provides access to the virtual execution environment necessary to process the program code and engage the physical infrastructure 114. Cryptographic trust services 118 may be used to verify transactions such as asset exchange transactions and keep information private.

The blockchain architecture configuration of FIG. 1A may process and execute program/application code 120 via one or more interfaces exposed, and services provided, by blockchain platform 112. The code 120 may control blockchain assets. For example, the code 120 can store and transfer data, and may be executed by nodes 104-110 in the form of a smart contract and associated chain code with conditions or other code elements subject to its execution. As a non-limiting example, smart contracts may be created to execute a transaction (e.g., purchase, subscription, activation, service upgrade, etc.), reminders, updates, and/or other notifications subject to the changes, updates, etc. The smart contracts can themselves be used to identify rules associated with authorization and access requirements and usage of the ledger. For example, the document attribute(s) information 126 may be processed by one or more processing entities (e.g., virtual machines) included in the blockchain layer 116. The result 128 may include multiple linked shared documents. The physical infrastructure 114 may be utilized to retrieve any of the data or information described herein.

A smart contract may be created via a high-level application and programming language, and then written to a block in the blockchain. The smart contract may include executable code, which may be registered, stored, and/or replicated with a blockchain (e.g., distributed ledger or distributed network of blockchain peers). A transaction is an execution of the smart contract code that can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chain code may include the code interpretation of a smart contract, with additional features. As described herein, the chain code may be program code deployed on a computing network, where it is executed and validated by chain validators together during a consensus process. The chain code receives a hash and retrieves from the blockchain a hash associated with the data template created by use of a previously stored feature extractor. If the hashes of the hash identifier and the hash created from the stored identifier template data match, then the chain code sends an authorization key to the requested service. The chain code may write to the blockchain data associated with the cryptographic details.

FIG. 1B illustrates an example of a blockchain transactional flow 100B between nodes of the blockchain in accordance with various embodiments. In the illustrated example, the transactional flow may include a transaction proposal 191 sent by an application client node 160 to an endorsing peer node 181. The endorsing peer 181 may verify the client signature and execute a chain code function to initiate the transaction. The output may include the chain code results, a set of key/value versions that were read in the chain code (read set), and the set of keys/values that were written in chain code (write set). The proposal response 192 is sent back to the client 160 along with an endorsement signature, if approved. The client 160 assembles the endorsements into a transaction payload 193 and broadcasts it to an ordering service node 184. The ordering service node 184 then delivers ordered transactions as blocks to all peers 181-183 on a channel. Before committal to the blockchain, each peer 181-183 may validate the transaction. For example, the peers may check the endorsement policy to ensure that the correct allotment of the specified peers have signed the results and authenticated the signatures against the transaction payload 193.

The client node 160 initiates the transaction 191 by constructing and sending a request to the peer node 181, which is an endorser. The client 160 may include an application leveraging a supported software development kit (SDK), which utilizes an available API to generate a transaction proposal. The proposal is a request to invoke a chain code function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 181 may verify: (a) that the transaction proposal is well formed; (b) that the transaction has not been submitted already in the past (replay-attack protection); (c) that the signature is valid; and (d) that the submitter (client 160, in the example) is properly authorized to perform the proposed operation on that channel. The endorsing peer node 181 may take the transaction proposal inputs as arguments to the invoked chain code function. The chain code is then executed against a current state database to produce transaction results including a response value, read set, and write set. However, no updates are made to the ledger at this point. In operation 192, the set of values, along with the endorsing peer node's 181 signature is passed back as a proposal response 192 to the SDK of the client 160 which parses the payload for the application to consume.

In response, the application of the client 160 inspects/verifies the endorsing peers signatures and compares the proposal responses to determine if the proposal response is the same. If the chain code only queried the ledger, the application would inspect the query response and would typically not submit the transaction to the ordering service node 184. If the client application intends to submit the transaction to the ordering service node 184 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in operation 193 the client 160 assembles endorsements into a transaction and broadcasts the transaction proposal and response within a transaction message to the ordering service node 184. The transaction may contain the read/write sets, the endorsing peer's signatures and a channel ID. The ordering service node 184 does not need to inspect the entire content of a transaction in order to perform its operation, instead the ordering service node 184 may simply receive transactions from all channels in the network, order them chronologically by channel, and create blocks of transactions per channel.

The blocks of the transaction are delivered from the ordering service node 184 to all peer nodes 181-183 on the channel. The transactions 194 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 195 each peer node 181-183 appends the block to the channel's chain, and for each valid transaction the write sets are committed to current state database. An event is emitted, to notify the client application that the transaction (invocation) has been immutably appended to the chain, as well as to notify whether the transaction was validated or invalidated.

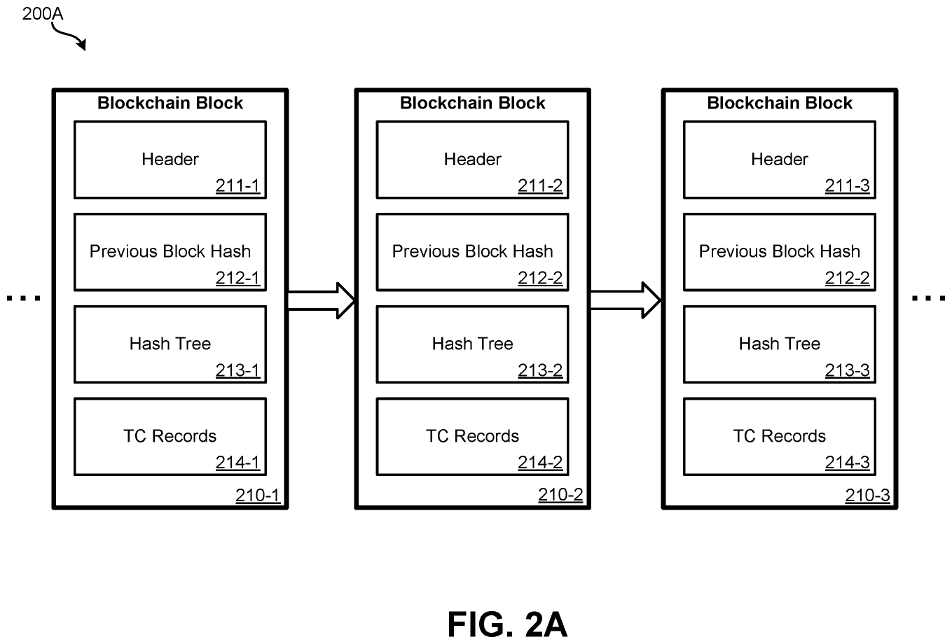

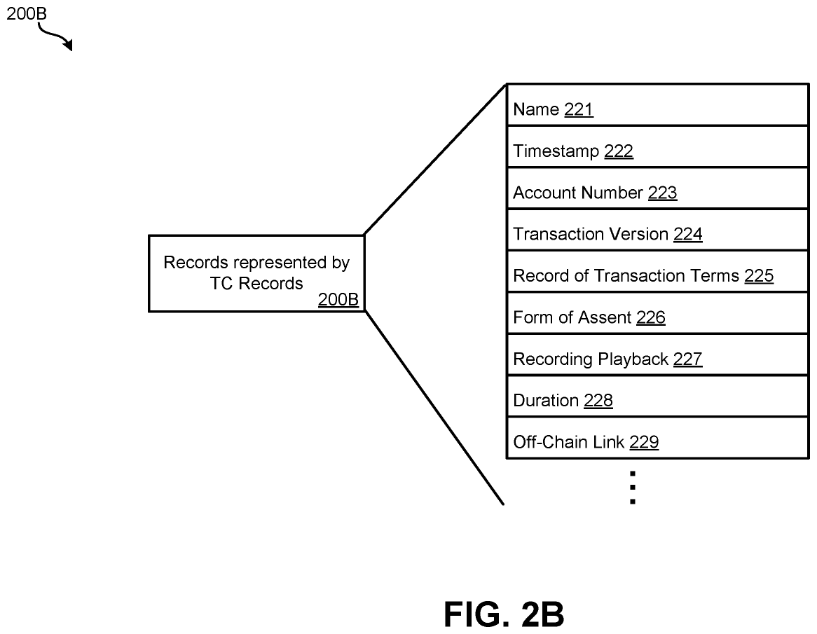

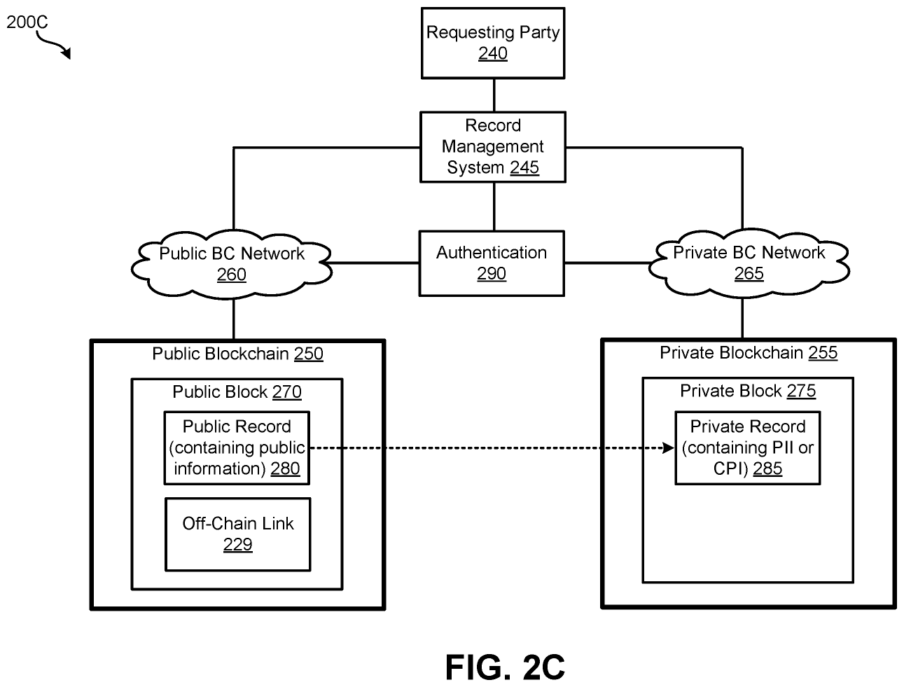

FIG. 2A illustrates a block diagram of an example blockchain 200A used to store terms and conditions (which can be a form of transaction) according to various embodiments. In the illustrated example, the blockchain 200A includes multiple blockchain blocks (BC blocks or blocks) 210 (e.g., BC blocks 210-1, 210-2, and 210-3). The “block” as used herein refers to a discrete, cryptographically hashed, and immutable collection of data containing multiple verified transactions or other digital information, which is added to a blockchain in a sequential and chronological order. Each block 210 further includes, among other components, include headers 211 (e.g., headers 211-1, 211-2, and 211-3 respectively for BC blocks 210-1, 210-2, and 210-3); previous block hashes 212 (e.g., block hashes 212-1, 212-2, and 212-3 respectively for BC blocks 210-1, 210-2, and 210-3); hash trees 213 (e.g., hash trees 213-1, 213-2, and 213-3 respectively for BC blocks 210-1, 210-2, and 210-3); and transactions 214 (also known as transactions records or TC records). As illustrated, the transactions 214 may include transactions 214-1, 214-2, and 214-3 respectively for BC blocks 210-1, 210-2, and 210-3.

Transactions 214 can be individual units of action or data that capture specific events or interactions, encompassing a wide range of activities, including financial transactions, contractual agreements, or any action that needs to be recorded. In some embodiments, a transaction 214 can include one or more transaction records (also referred to as record and denoted as 214) that documents the content and details of the event included in the transaction, particularly, a record that indicates a consumer has assented to terms and conditions of a service provider (or manufacturer). Storing these transaction records within transactions 214 is a form of record-keeping, ensuring a clear and immutable history of events and consumer assent action.

FIG. 2B illustrates an exemplary transaction or transaction record 200B represented by the transactions 214 of FIG. 2A according to various embodiments. The record 200B can show various types of the record containing various transaction information of a transaction. In the illustrated example of FIG. 2B, the record 200B can include various pieces of information, such as: name 221; timestamp 222; account number 223; transaction version 224; transaction terms 225; form of assent 226; recording playback 227; duration 228; and an off-chain link 229, among others.

Name 221 can refer to the legal name of the consumer who is assenting to the terms and conditions included in the transaction. Account number 222 can refer to an account number, generated by the service provider, of the consumer who participated in the transaction and assented to the transaction terms 225. Since the account number 222 can be expected to be unique, the account number may be one of the most efficient ways to look up a record in transactions 214. Transaction version 224 refers to a distinct iteration of a transaction within the blockchain 200A. Transaction version is commonly used to manage updates or changes to a transaction while preserving data history. When modifications are made to a transaction, each updated instance is assigned a new version number or ID. The version number enables users to maintain an auditable record of all changes to support data integrity and facilitate comparisons between different iterations of the same transaction or related transactions. The version of the transactions to which the consumer provided their assent can be securely recorded and represented as a non-fungible token (NFT). The NFT can capture key information, such as a wet ink signature, a digital signature from the consumer, or other forms of evidentiary data, effectively verifying and memorializing their agreement. Additionally, a duplicate set of these transactions can be stored at a predefined blockchain address, and a reference link to this storage location can be incorporated within record 200B. Accordingly, the preservation and accessibility of the agreed-upon transaction version can be achieved.

The record of transaction terms 225 can serve as documentation specifying the precise terms and conditions to which the consumer has given their assent during the same transaction or related transactions. Notably, in certain implementations, each individual record within the collection of transaction terms 225 corresponds directly to a specific transaction version 224. These records, designated by their transaction version IDs, can record the exact terms and conditions to which the consumer has provided their agreement, as well as a detailed and comprehensive record of assent for each transaction version.

Form of assent 226 of record 200B can indicate how the consumer assented to the transactions, such as by authenticating the consumer watching the video, clicking an accept button as part of a GUI; scrolling through the transactions; typing in a/s signature, speaking a passphrase or acknowledgment as a voice/audio recognition, providing fingerprint scans, facial recognition, or retina scans as a form of assent, entering a one-time password (OTP) as part of the assent process, clicking a link in a received confirmation email to confirm the assent, scanning a QR code with a mobile device, using a smart card with a chip that contains encrypted data for authentication, entering a personal identification number (PIN) or a passcode as a form of assent, recording a video statement or acknowledgment as a form of assent (video verification), leveraging blockchain technology to confirm and record the consumer's assent securely, among others.

In some embodiments, the NFT can record all the components of the transaction, such as providing the terms via text, video or audio, assent of the consumer, and details such as consumer information, timestamp of the assent, details of the terms of the transactions, etc. into a single file, which is stored as an NFT. For example, all relevant components of the transaction are gathered, including the textual description of terms, video or audio recordings, the form of assent, and any additional details like consumer identification and timestamps. The gathered data is serialized and structured into a single file or format that can be easily represented within an NFT. A new NFT can be created or minted on a blockchain that supports NFTs, such as Ethereum. The NFT represents the serialized transaction data, making it a unique and non-fungible digital asset. The NFT can be typically assigned to the appropriate parties involved in the transaction, such as the consumer and the service provider or manufacturer to establishes clear ownership rights and responsibilities. The NFT, containing the entire transaction record, is securely stored on the blockchain and becomes an immutable and tamper-proof record to safeguard the transaction's integrity. All parties involved in the transaction can independently verify the transaction data by referencing the NFT. Smart contracts can be used to automate actions or processes based on the contents of the NFT. For example, the release of funds or the activation of services can be triggered when the conditions specified in the NFT are met.

In some embodiments, since transactions can be exceptionally long and hard to understand by average consumers, video recordings (or audio recordings) may be provided. These video or audio recordings can be an integral part of the transaction, replacing the conventional textual form of the transaction. In some embodiments, the consumer's assent can be captured by recording the consumer watching the video or listening to the audio. Alternately, the video or audio can offer the consumer an audiovisual key, which is later used to authenticate and record the consumer's assent to the transaction. For example, the consumer watches a video illustrating the key aspects of a transaction, and embedded within the video is a picture of a horse. Once the consumer finishes watching the video, the consumer can accept the terms of the transaction by choosing the picture of a horse from a myriad of animal pictures. This verifies that the consumer has watched the video and is accepting the transaction. Such video or audio recordings not only represent a legally-binding contract, they can also be useful in helping the consumer understand key aspects of the transactions. To later establish that a consumer was made aware of particular aspects of the transactions, it may be beneficial to record as part of record 200B, whether a consumer interacted with an audio or video recording, for how long, and whether the consumer verified the transaction (e.g., by selecting the appropriate image that was embedded therein). If interacted with (e.g., viewed, listened to, verified, or otherwise accessed by the consumer), an NFT may be created that is uniquely associated with and is permanently linked to the video/audio recording playback 227 as part of record 200B. Information about the duration for which the consumer accessed the recording can also be included as part of record 200B, for example, as a separate record of duration 228 related to the recording playback 227.

In some embodiments, the service provider or manufacturer may have a significant amount of information about the consumer that is not to be recorded directly as part of the blockchain. For example, if the blockchain used to store records such as record 200B is a public blockchain, personally identifiable information (PII) or customer protected information (CPI) may be stored in a secure server, but linked to the record on the blockchain. As an example, “name” may not be included as a field in record 200B, but off-chain link 229 may be an identifier or universal resource locator (URL) that allows the service provider to access data stored off chain that is related to record 200B (such as the consumer's name, address, phone number, social security number, etc.). Depending on the regional data protection laws and regulations, some other information may also belong to PII or CPI, such as email address, date of birth, government-issued ID, certain financial information such as bank account numbers, credit card numbers, biometric data, IP addresses, transaction history, username, health information, legal documents, and so on.

FIG. 2C is a block diagram illustrating an example of a hybrid blockchain system 200C (hereinafter system 200C) for accessing public and private records related to a transaction. In the illustrated example, the blockchain system 200C includes, among other components, a requesting party 240, a record management system 245, a public blockchain 250 (or public distributed ledger), a private blockchain 255 (or private distributed ledger), a public blockchain network 260, a private blockchain network 265, and an authentication component or authentication server 290. The public blockchain 250 further includes one or more public blocks 270. Each public block includes one or more public records 280 containing publicly available information regarding the transaction as well as an off-chain link (e.g., the off-chain link 229 of FIG. 2B). The private blockchain 255 further includes one or more private blocks 275. Each private block 275 further includes one or more private records 285 containing PII or CPI. As illustrated, public blockchain 250 provides transparency, while private blockchain 255 ensures data privacy, and the combination of public and private blockchains in the hybrid blockchain system 200C is can balance transparency and data privacy.

The requesting party 240 is an entity or user that initiates a request to access specific private records related to a transaction. The requesting party 240 may submit a request for accessing a record related to a transaction to the record management system 245. The record management system 245 is in communication with the public blockchain 250 through the public blockchain network 260 and in communication with the private blockchain 255 through the private blockchain network 265. The record management system 245 may determine whether the record requested by the requesting party is a public record or a private record, whether the requested record contains PII or CPI. The record management system 245 may identify the public block 270 or private block 275 where the requested record is stored. The record management system 245 may grant the requesting party access to the public block 270. If the request record is stored in a private block 275 and/or contains PI or CPI, the requesting party may use the off-chain link 229 to access the private record 285. In some embodiments, the requested party may need to be authenticated or authorized to access the private record 285. The authentication server 290 may perform authentication. The authentication performed by the authentication server 290 may employ various methods such as username and password authentication, multi-factor authentication (MFA), API keys, token-based authentication, cryptographic key based authentication, and so on. In some embodiments, the requesting party 240 provides the necessary authentication credentials or factors to prove their identity and authorization. The authentication server 290 verifies the provided authentication credentials to ensure that they match the authorized party's provided information. Once authenticated, the requesting party 240 is granted access to the private block 275 stored in the private blockchain 255 to retrieve the private record containing sensitive transaction information.

Now referring back to FIG. 2A, for each record, such as record of transaction 214-2, or a defined number of records, a cryptographic hash is created. This hash is based on the values within record 214-2 (or the defined group of records). Therefore, if the record was altered, the hash would no longer match, and it would be known that the record has been altered. Hashes from multiple records with transaction records 214-2 or groups of records within transaction records 214-2 are then hashed together. Within BC block 210-2, a tree of hashes (or Merkle tree) can be built until, for example, a defined number of transaction records 214-2 have been included as part of BC block 210-2. Such trees allow for records to be efficiently added to block 210-2 as it is constructed such that all of the previous transaction records added to the BC block 210-2 do not need to be again analyzed to be included in the hash calculation (rather, only their hash is included in the calculation of the next level of the hash tree). At the top of the hash tree, a root hash is present. Hash values of the hash tree are stored as hash tree 213-2 within BC block 210-2.

Also stored within BC block 210-2 is header information, such as header 211-2. Header information may include basic information about BC block 210-2, such as an identifier to indicate its location in the chain, timestamp, and possibly data to be used for proof of work. Each BC block can also include a previous block hash, such as previous block hash 212-2. A previous block hash is a hash based on the header, hash tree, and previous block hash of the previous BC block. Therefore, for example, for BC block 210-2, previous block hash 212-2 is cryptographically constructed based on a hash of: header 211-1; previous block hash 212-1; and hash tree 213-1 (of which only the root hash may be used). This previous block hash prevents changes from being made to any earlier block without every later block's previous block hash being affected. As such, tampering with earlier blocks can be readily detected.

Over time, additional BC blocks are added to the BC chain, with their included transaction records 214 being permanently memorialized within the blockchain.

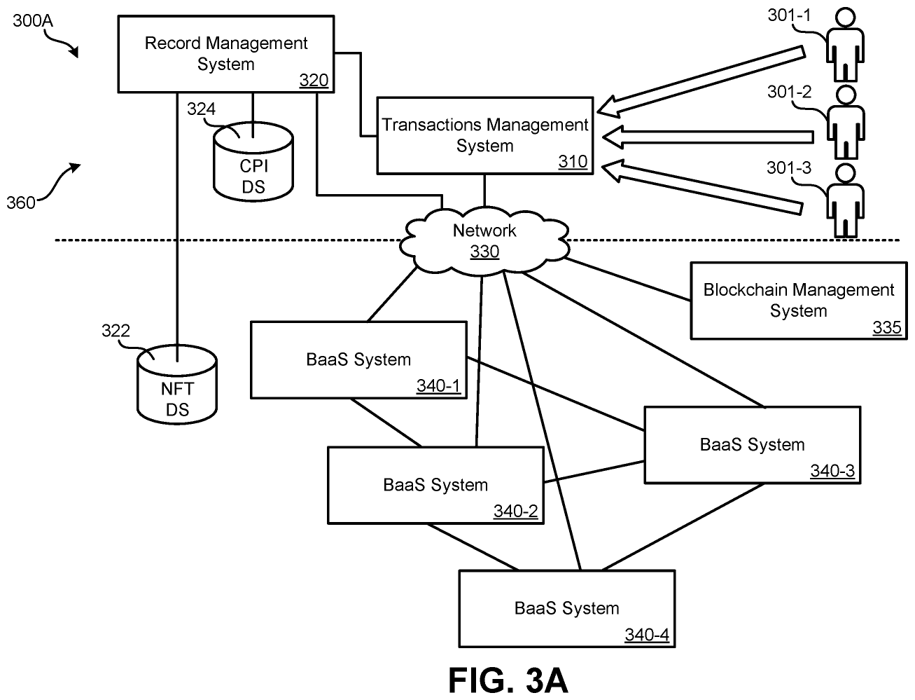

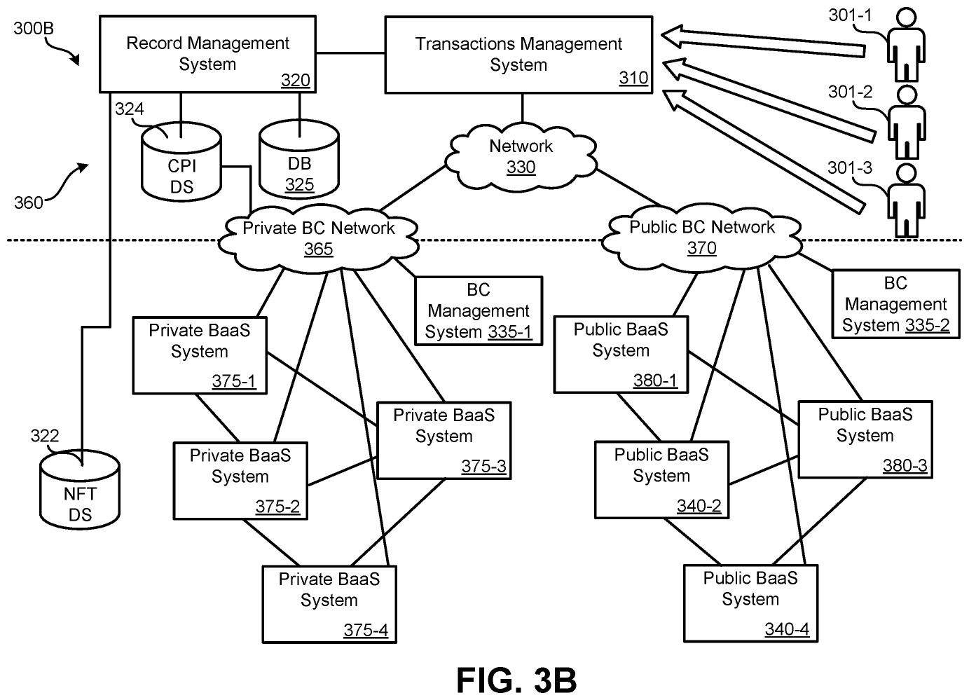

By using a distributed digital ledger to maintain the BC, the possibility of any editing of a recorded block on the blockchain is extremely difficult. Embodiments detailed herein can be implemented using a blockchain that is stored and maintained using a public distributed digital ledger or a private distributed digital ledger. FIG. 3A illustrates a block diagram of an example system 300A for using a private distributed ledger to maintain a blockchain of transaction. In other embodiments, a public distributed digital ledger system may be used, such as Ethereum. In the illustrated example, system 300A can include, among other components, a transactions management system 310; a record management system 320; an NFT Datastore 322; a CPI datastore 324; a blockchain network 330; a blockchain management system or server 335; one or more blockchain as a service (BaaS) systems 340. In some embodiments, the BaaS system 340 is a private BaaS system. In alternative embodiments, the BaaS system 340 is a public BaaS system. The BaaS system 140 is used along with a management system 360 maintained by a service provider.

Initially, consumers, such as consumers 301, can review and assent to transactions via transactions management system 310. Alternatively, the transactions may be consented to on paper, and electronic copies of such signed (or otherwise assented to transactions) may be received by transactions management system 310. If consumers 301 watched or listened to any videos or recordings, information related to such recordings (e.g., reference to which videos or audio recordings were presented, duration of time for which they were presented) may be added to a record by transactions management system 310.

Records about consumers can be stored using record management system 320. One or more datastores using non-transitory processor-readable mediums may be stored, such as NFT Datastore 322 and CPI Datastore 324. CPI Datastore 324 may be used to store consumer-specific information that is not desirable to store directly on a public block or a public blockchain, but is linked to a blockchain record. For example, a consumer's financial information, address, contact information, name, etc. may be stored in CPI Datastore 324 and linked to one or more blockchain records, such as via an off-chain link maintained on the blockchain. A similar link may be stored in CPI Datastore 324 to reference records on the blockchain relevant to the consumer. Access to record management system 320 may be restricted such that only authorized parties, such as administrators of the service provider operating transactions management system 310 or a requesting party that is authenticated to access the CPI Datastore 324, can access CPI Datastore 324 and NFT Datastore 322.

NFT Datastore 322 can be where NFTs are stored, such as images of signed transactions, versions of transactions, recordings of videos or audio recordings presented to consumers along with the transactions. These NFTs may be linked to records on the blockchain. Once stored in NFT Datastore 322, these links may be maintained as active as long as possible such that the links within records on the blockchain (which cannot be edited) correctly reference their intended NFT. That is, link rot is to be avoided.

Network 330 can represent the internet, some other public network, a private network, or some combination thereof. The transactions management system 310 can provide records to be added to the blockchain to blockchain as a service (BaaS) system 340. BaaS system 340 may also be maintained by a third-party that maintains a private or public distributed ledger system, such as the blockchain management system 335. In some embodiments, a public ledger may be used, such as Ethereum, to create the records. BaaS system 340 may make use of a group of distributed computer server systems that record, share, and synchronize transactions to ensure that the blocks maintained across the digital ledger are the same. Therefore, by maintaining the blocks across the computer systems of BaaS system 340, surreptitiously editing any previous block is extremely difficult due to: 1) the cascade effect on hashes of later blocks; and 2) the block needing to be surreptitiously edited on multiple independent systems. As needed by transactions management system 310, the records in previous blocks of the blockchain can be inspected to determine the circumstances of when a user consented to particular transactions.

The BaaS system 340 provides infrastructure and services to support the creation and management of blockchain. In some embodiments, a BaaS system 340 includes a blockchain infrastructure including the blockchain network, nodes and the underlying consensus mechanism for validating transactions, creating blocks, and maintaining the blockchain ledger. The BaaS system 340 further includes a node management component responsible for managing the nodes that participate in the blockchain network, organizing the nodes into various roles, such as validating nodes, mining nodes, and peer node, as well as provisioning, maintaining, and monitoring of these nodes. The BaaS system 340 further includes a blockchain configuration component that allow users to configure the blockchain network according to specific requirements and set parameters such as block size, block time, consensus algorithm, and other network rules. The BaaS system 340 may further include a transaction record management component responsible for storing, organizing, indexing, and versioning transaction data on the blockchain to ensures that transaction records are correctly formatted, timestamped, and securely stored; a data privacy and encryption component responsible for protecting sensitive data by encrypting it before adding it to the blockchain; an off-chain storage integration component responsible for managing the off-chain data and creating secure links or references on the blockchain; an access control component responsible for regulating and managing access to various resources and records within the blockchain network and the BaaS system.

FIG. 3B illustrates a block diagram of an example system 300B for using a hybrid system of distributed ledgers to maintain a blockchain of transaction. System 300B is a close variation of system 300A and may include similar components thereof. In the illustrated example, system 300B includes, among other components, a transactions management system 310, a record management system 320, network 330, a private blockchain network 365, a public blockchain network 370, one or more private BaaS systems 375 connected to the private blockchain network 365, one or more public BaaS systems 380 connected to the public blockchain network 370, a first blockchain management system or server 335-1 responsible for managing the private BaaS systems 375, and a second blockchain management system or server 335-2 responsible for managing the public BaaS systems 380. The private BaaS systems 375 and the public BaaS systems 380 are variations of the BaaS system 340.

Private BaaS systems 375 are specialized blockchain infrastructure and service platforms designed to support the creation, management, and operation of private or consortium blockchains. Private BaaS systems 375 are tailored for use within a specific organization, industry, or closed group of participants to facilitate the development and deployment of private blockchains that are not accessible to the general public. Private BaaS systems 375 are typically isolated from public networks to ensure that transactions and data are kept within the defined network boundaries. As mentioned above, private records containing PII or CPI may be stored in the private blocks of the blockchain created and managed by the private BaaS systems 375.

Public BaaS systems 380 may be cloud-based platforms that provide infrastructure and services for organizations and developers to create, deploy, and interact with public blockchain networks. The public BaaS systems 380 are designed for use in the broader blockchain ecosystem and are accessible to the general public. As mentioned above, public records containing non-sensitive information or otherwise publicly available information may be stored in the public blocks of the blockchain created and managed by the public BaaS systems 380.

The record management system 320 may determine whether the information related to the transaction provided by the transactions management system 310 is a PII or CPI, based on predetermined rules stored in and retrievable from the database 325 in connection with the record management system 320. The CPI Datastore 324 may store any transaction information that is determined to be PII or CPI. The transaction information determined to be PII or CPI may be releasable to the private BaaS systems 375 included in private records stored in private blocks. On the other hand, the non-sensitive information may be releasable to the public BaaS system 380 and included in public records stored in public blocks.

Employing the hybrid system 300B that combines both private BaaS systems and public BaaS systems provide advantages when dealing with sensitive and non-sensitive transaction data. Sensitive information, such as personally identifiable data, can be segregated and securely stored in private BaaS systems, which only provides restricted access to trusted parties. Simultaneously, non-sensitive transaction data can reside in public BaaS systems to ensure their transparency and accessibility.

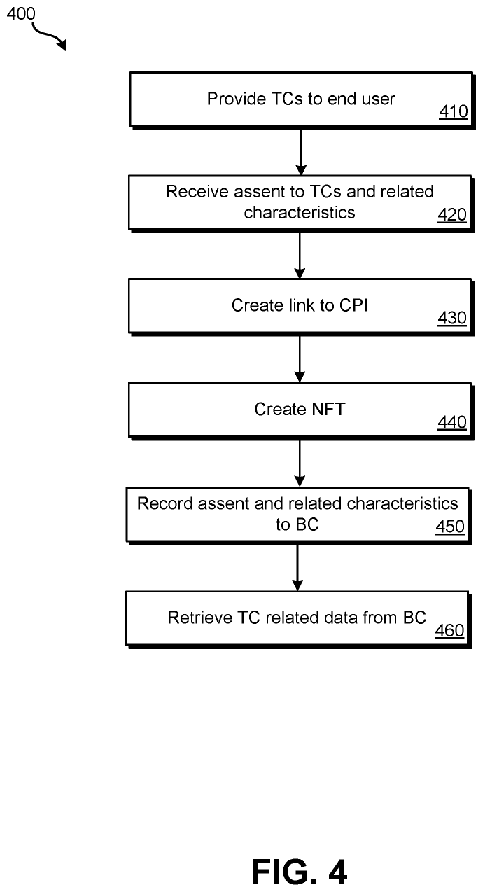

Various methods can be performed using the systems and arrangements of FIGS. 1A-3B. FIG. 4 is a flow diagram illustrating an example method 400 for using a distributed ledger to maintain a blockchain of transaction according to various embodiments. The method 400 may be implemented by one or more components included in the systems described herein. Depending on the implementation, the method 400 may include additional, fewer, or alternative steps performed in various orders or in parallel.

At block 410, transactions are provided to a consumer. The transactions may have a particular version number and/or date. These transactions may pertain a specific service that the consumer desires from a service provider or manufacturer. For example, the transactions may pertain to a cellular subscription.

At block 420, assent to the transactions is received from the consumer along with related characteristics. The assent may be in a particular form to a particular version of transaction. In some embodiments, the assent may correspond to particular transaction terms. A record may be created that indicates aspects of the transactions to which assent has been received. The created record or the data collected can include: the consumer's name; a timestamp at which the transactions were assented to (or that this record was created); an account number of the consumer with the service provider; a transaction version indicator; a document (i.e., a digital copy) of the transaction terms, an indication of the form of assent; an indication of whether a recording playback occurred along with an indication of which recording was output; an indication of a duration for which playback was output; and an off-chain link to other stored information.

At block 430, a link or reference to CPI or some other form of protected information can be created. This reference can be used to access consumer specific data that is not to be stored directly on the blockchain. For example, the name of the consumer, the consumer's address, and contact information may be stored in a secure database, to which a reference to the consumer's entry is included on the blockchain. This reference or link can allow a blockchain record to be created that indicates assent to transactions but does not reveal information about the consumer. Such a reference may be particularly important if the distributed ledger system used is public.

At block 440, an NFT can be created for recording to the blockchain as part of the record. The NFT can involve storing a link to a document (e.g., an image) stored at a particular location to which the link points. The document can be either the executed transactions; or image of signed transactions. Instead of a document, the NFT can be a video or audio recording which has been provided to the consumer for playback. In some embodiments, a proof of playback or indication of the amount of time that the recording was played back is recorded to the blockchain.

At block 450, a record is created on the blockchain that indicates assent to the transactions and related characteristics. The creation of the record in a block of the blockchain can involve the link to the CPI of block 430, one or more NFTs of block 440, or both. Once created in the block and recorded to the blockchain, no changes can be made to the record.

At block 460, at some future time, transaction related data is retrieved from the blockchain. For example, many years after a transaction is recorded, a dispute may arise that requires the transactions to which the consumer assented to be accessed and reviewed. The blockchain may be used to access the transactions assented to by the consumer, determine the version of transactions, determine how the consumer assented; and identify other circumstances related to the transactions. For instance, a company may be able to provide evidence in a legal proceeding as to whether the consumer accessed and read the text or watched the video recording, along with the specific version of the transactions that e.g., that the consumer viewed a video detailing the transactions.

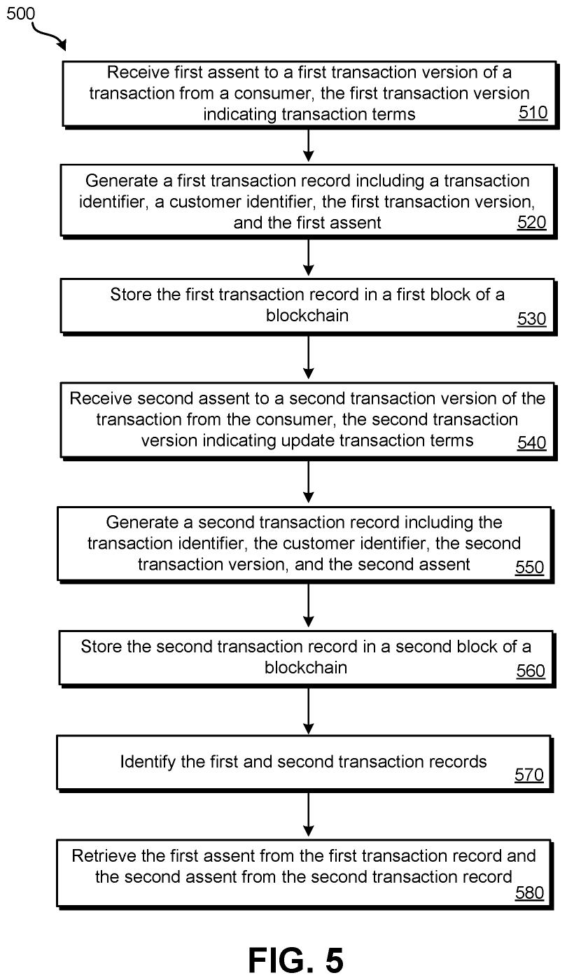

FIG. 5 is a flow diagram illustrating another example method 500 for using a distributed ledger to maintain a blockchain of transaction according to various embodiments. The method 400 may be implemented by one or more components included in the systems described herein. Depending on the implementation, the method 500 may include additional, fewer, or alternative steps performed in various orders or in parallel.

At 510, first assent to a first transaction version of a transaction is received, in a transaction management system, from a consumer. The first transaction version indicates and includes transaction terms and conditions to which the consumer assented.

At 520, a first transaction record is generated, by a record management system. The first transaction record includes, among other components, a transaction identifier (ID), a customer ID (e.g., a customer account number), the first transaction version, the transaction terms and conditions corresponding to the transaction version, as well as the first assent.

At 530, the first transaction record is stored, by a BaaS system, in a first block of a blockchain. In some embodiments, the first block is a private block, and the first transaction record is stored in the private block, which is only accessible by authorized or authenticated parties. In some embodiments, the first block is a public block, and the first transaction record is stored in the public block, which can be publicly accessible. In some embodiments, the first transaction record may be divided into one or more first private records and one or more first public records. The first private records contain PPI or CPI, and the first public records contain non-sensitive information. The first private records may be stored by a private BaaS system, in a first private block of a private blockchain. The first public records may be stored by a public BaaS system, in a first public block of a public blockchain. The first public records may further include an off-chain link to the first private records.

At 540, second assent to a second transaction version of the transaction is received, in the transaction management system, from the consumer. The second transaction version indicates and includes an updated version of transaction terms and conditions (i.e., updated transaction terms and conditions) to which the consumer assented.

At 550, a second transaction record is generated, by the record management system. The second transaction record includes, among other components, the transaction identifier, the customer ID, the second transaction version, the updated transaction terms and conditions corresponding to the transaction version, as well as the second assent.

At 560, the second transaction record is stored, by a BaaS system, in a second block of the blockchain. In some embodiments, the second block is a private block, and the second transaction record is stored in the private block, which is only accessible by authorized or authenticated parties. In some embodiments, the second block is a public block, and the second transaction record is stored in the public block, which can be publicly accessible. In some embodiments, the second transaction record may be divided into one or more second private records and one or more second public records, in a similar manner as the first transaction record. The second private records contain PPI or CPI, and the second public records contain non-sensitive information. The second private records may be stored by a private BaaS system, in a second private block of the private blockchain. The second public records may be stored by a public BaaS system, in a second public block of the public blockchain. The second public records may further include an off-chain link to the second private records.

In some embodiments, a reference used to direct to the first block is also created and stored in the second block. The reference may include metadata or information that is stored within the second transaction record (generated for the updated transaction version) and points back to the first transaction record (associated with the initial transaction version). The reference is used to create a clear and unambiguous connection between the two transaction records to ensure that they are related and that the history of assents and transaction versions can be tracked.

At 570, the first and second transaction records are identified, by the record management system, in response to a request for access from a requesting party. The first and second transaction records may be identified by the transaction ID, the consumer ID, the reference stored in the second block, or any other information that are common to the first and second transaction records.

At 580, the first assent and the second assent are respectively retrieved from the first transaction record and the second transaction record. In some embodiments, an authentication is performed to authenticate the requesting party prior to the retrieval of the first and second assent, if the first transaction record and the second transaction record contain PII or CPI. In some embodiments, the off-chain link included in the first and/or second public record may be used by the requesting party to access the corresponding first and/or second private record.

It should be noted that the first transaction record may be created to record the initial transaction terms and conditions as well as the initial assent at a first time point, and the second transaction record may be created to record the updated transaction terms and conditions and the updated assent at a second time point subsequent to or later than the first time point.

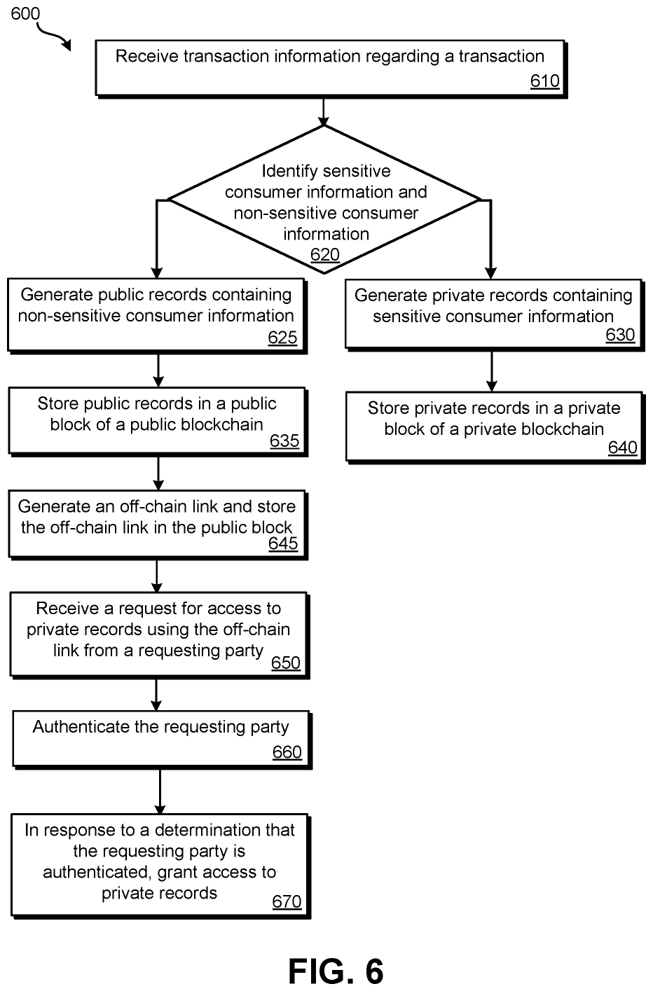

FIG. 6 is a flow diagram illustrating another example method 600 for using a distributed ledger to maintain a blockchain of transaction according to various embodiments. The method 400 may be implemented by one or more components included in the systems described herein. Depending on the implementation, the method 600 may include additional, fewer, or alternative steps performed in various orders or in parallel.

At 610, transaction information regarding a transaction is received in a transactions management system. The transaction information may include, among other things, transaction terms and conditions, and consumer assent to the transaction terms and conditions. The transaction information may include non-sensitive consumer information, sensitive consumer information (e.g., PII or CPI), or a combination of both.

At 620, a determination is made on whether the consumer information is sensitive or non-sensitive, by the transactions management system, based on predetermined regulations or rules. In some embodiments, the consumer information is further discerned into sensitive consumer information and non-sensitive consumer information.

At 625, one or more public records containing non-sensitive consumer information are generated, by a record management system. At 630, one or more private records containing sensitive consumer information (e.g., PII or CPI) are generated, by the record management system.

At 635, the public records are stored, by a public BaaS system, in a public block of a public blockchain. At 640, the private records are stored, by a private BaaS system, in a private block of a private blockchain. In some embodiments, the private records are stored in a private server system such as a database (e.g., the CPI Database of FIG. 3A) included in a private server system.

At 645, an off-chain link directed to the corresponding private records associated with the same transaction is generated, by the public BaaS or a blockchain management system in connection with the public BaaS system. The generated off-chain link may be stored in the public block. In some embodiments, the off-chain link may be stored as an individual and isolated public record in the public block.

At 650, a request for access to the private records associated with the transaction using the off-chain link is received from a requesting party. The request may be received in the record management system or the blockchain management system in connection with the public BaaS.

At 660, in response to the request, an authentication process is performed, by an authentication server, to authenticate the requesting party. In some embodiments, credentials are provided by the requesting party and sent from the requesting party to the authentication server, and the authentication process may employ various methods to verify the requesting party's identity using the provided credentials.

At 670, in response to a determination that the requesting party is authenticated, access to private records is granted to the requesting party, by the record management system, the private BaaS system, or the associated blockchain management system.

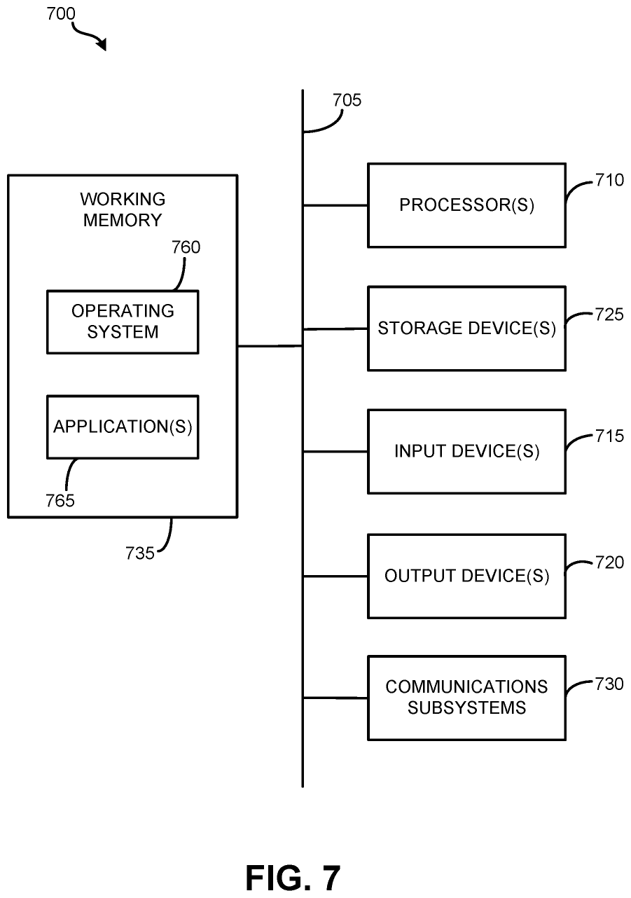

FIG. 7 is a high-level block diagram illustrating an example of computer system 700. The computer system 700 is a simplified computer system that can be used to implement various embodiments described and illustrated herein. A computer system 700 as illustrated in FIG. 7 may be incorporated into devices such as a portable electronic device, mobile phone, server grade machines, or other device as described herein. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, solid state drive, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a record” includes a plurality of such records, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the disclosure.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the disclosure. Rather, the preceding description of the embodiments will provide those skilled in the art with an enabling description for implementing embodiments of the disclosure. Various changes may be made in the function and arrangement of elements without departing from the spirit and scope of the disclosure.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the disclosure. For example, the above elements may merely be a component of a larger system, wherein other rules may take precedence over or otherwise modify the application of the disclosure. Also, a number of steps may be undertaken before, during, or after the above elements are considered. Accordingly, the above description should not be taken as limiting the scope of the disclosure.

What is claimed is:

1. A system for maintaining transaction records using a distributed ledger, the system comprising:
one or more processors; and
a computer-readable storage media storing computer-executable instructions that, when executed by the one or more processors, cause the system to:
receive transaction information associated with a transaction involving a service provider and a consumer, the transaction information comprising transaction terms and conditions;
receive an indication, the indication indicating that the consumer assented to the terms and conditions;
create a transaction record, the transaction record comprising a transaction identifier, a consumer identifier of the consumer, the transaction terms and conditions, and the indication;
create a block in a blockchain managed by a blockchain as a service (BaaS) system; and
store the transaction record in the block.

2. The system of claim 1, wherein the transaction record further comprises a reference to customer protected information (CPI) stored on a private server system.

3. The system of claim 1, wherein the transaction record further comprises a non-fungible token that references the transaction terms and conditions and the indication.

4. The system of claim 3, wherein the non-fungible token references a video or audio recording that contains the transaction terms and conditions and the consumer's assent to the transaction terms and conditions.

5. The system of claim 1, wherein the instructions when executed by the one or more processors further cause the system to:
receive a request for access to the transaction record from a requesting party; and
grant access to the transaction record to the requesting party.

6. The system of claim 2, wherein the instructions when executed by the one or more processors further cause the system to:
receive a request for access to the CPI of the transaction record using the reference from a requesting party;
authenticate the requesting party; and
in response to a determination that the requesting party is authenticated, grant access to the CPI to the requesting party.

7. A method comprising:
receiving transaction information associated with a transaction involving a service provider and a consumer, the transaction information comprising transaction terms and conditions;
receiving an indication, the indication indicating that the consumer assented to the terms and conditions;
creating a transaction record, the transaction record comprising a transaction identifier, a consumer identifier of the consumer, the transaction terms and conditions, and the indication;
creating a block in a blockchain managed by a blockchain as a service (BaaS) system; and
storing the transaction record in the block.

8. The method of claim 7, wherein the transaction record further comprises a reference to customer protected information (CPI) stored on a private server system.

9. The method of claim 7, wherein the transaction record further comprises a non-fungible token that references the transaction terms and conditions and the indication.

10. The method of claim 9, wherein the non-fungible token references a video or audio recording that contains the transaction terms and conditions and the consumer's assent to the transaction terms and conditions.

11. The method of claim 7, further comprising:
receiving a request for access to the transaction record from a requesting party; and
granting access to the transaction record to the requesting party.

12. The method of claim 8, further comprising:
receiving a request for access to the CPI of the transaction record using the reference from a requesting party;
authenticating the requesting party; and
in response to a determination that the requesting party is authenticated, granting access to the CPI to the requesting party.

13. A method comprising:
receiving first transaction information associated with a transaction involving a service provider and a consumer, the first transaction information comprising first transaction terms and conditions;
receiving a first indication, the first indication indicating that the consumer assented to the first terms and conditions at a first time point;
creating a first transaction record, the first transaction record comprising a transaction identifier, a consumer identifier of the consumer, the first transaction terms and conditions, and the first indication;
creating a first block in a blockchain managed by a blockchain as a service (BaaS) system;
storing the first transaction record in the first block;
receiving second transaction information associated with the transaction between the service provider and the consumer, the second transaction information comprising second transaction terms and conditions different from the first transaction terms and conditions;
receiving a second indication, the second indication indicating that the consumer assented to the second terms and conditions at a second time point subsequent to the first time point;
creating a second transaction record, the second transaction record comprising the transaction identifier, the consumer identifier of the consumer, the second transaction terms and conditions, and the second indication;
creating a second block in the blockchain; and
storing the second transaction record in the second block.

14. The method of claim 13, further comprising:
generating a reference to the first transaction record; and
storing the reference in the second block.

15. The method of claim 13, wherein the first transaction record and the second transaction record each further comprise an off-chain link to customer protected information (CPI) stored on a private server system.

16. The method of claim 13, wherein the first transaction record further comprises a first non-fungible token (NFT) that references the first transaction terms and conditions and the first indication.

17. The method of claim 16, wherein the first non-fungible token references a first video or audio recording that contains the first transaction terms and conditions and the consumer's assent to the first transaction terms and conditions.

18. The method of claim 13, wherein the second transaction record further comprises a second non-fungible token that references the second transaction terms and conditions and the first indication, and the second non-fungible token references a second video or audio recording that contains the second transaction terms and conditions and the consumer's assent to the second transaction terms and conditions.

19. The method of claim 13, further comprising:
receiving a request for access to transaction information regarding the transaction from a requesting party;
identifying the first transaction record and the second transaction record; and
granting access to the first transaction record and the second transaction record to the requesting party.

20. The method of claim 15, further comprising:
receiving a request for access to the CPI of the transaction record using the off-chain link from a requesting party;
authenticating the requesting party; and
in response to a determination that the requesting party is authenticated, granting access to the CPI to the requesting party.
